(19) United States
(12) Patent Application Publication
(10) Pub. No.: US 2025/0018415 A1
(43) Pub. Date: Jan. 16, 2025

(54) PROCESS CHAMBER GAS FLOW IMPROVEMENT

(71) Applicant: Applied Materials, Inc., Santa Clara, CA (US)

(72) Inventors: Errol Antonio C. SANCHEZ, Tracy, CA (US); Zuoming ZHU, Sunnyvale, CA (US)

(21) Appl. No.: 18/630,408

(22) Filed: Apr. 9, 2024

Related U.S. Application Data
(60) Provisional application No. 63/513,781, filed on Jul. 14, 2023.

(51) Int. Cl. B05B 13/02; B05B 12/04; B05B 12/32; B05B 14/30

(52) U.S. Cl. CPC B05B 13/0221; B05B 12/04; B05B 12/32; B05B 14/30

(57) ABSTRACT

A process chamber is provided including: a chamber body enclosing an interior volume; a first substrate support and a second substrate support each positioned in the interior volume, the first substrate support positioned over the second substrate support; a barrier positioned between the first substrate support and the second substrate support, the interior volume including a first portion above the barrier and a second portion below the barrier; a first gas inlet configured to provide gas to the first portion of the interior volume; and a recirculation passageway having a first port connected to the first portion of the interior volume and a second port connected to the second portion of the interior volume.

### RELATED APPLICATIONS

This application claims benefit of and priority to U.S. Provisional Patent Application No. 63/513,781, filed Jul. 14, 2023, the entire contents of which are incorporated herein by reference.

### BACKGROUND

Embodiments of the present disclosure generally relate to equipment and methods for providing one or more gases to the interior volumes of processing stations for performing processes (e.g., depositions) on substrates, such as semiconductor substrates.

### DESCRIPTION OF THE RELATED ART

Gases are provided to the interior volume of process chambers when performing a process on a substrate, such as a semiconductor substrate. The gases can interact with each other and/or one or more surfaces of the substrate to modify the substrate, for example by depositing a new layer on the substrate or removing material from the substrate. While some fraction of the gases provided to the interior volume of the process chamber interact with the surface of the substrate to perform the intended process (e.g., deposition) another fraction of the gases is exhausted from the process chamber without successfully interacting with the substrate and is thus essentially wasted.

Accordingly, there is a need for improved methods and equipment that can reduce the amount of waste associated with gases provided to the interior volumes of process chambers, such as semiconductor process chambers.

### SUMMARY

In one embodiment, a process chamber is provided including: a chamber body enclosing an interior volume; a first substrate support and a second substrate support each positioned in the interior volume, the first substrate support positioned over the second substrate support; a barrier positioned between the first substrate support and the second substrate support, the interior volume including a first portion above the barrier and a second portion below the barrier; a first gas inlet configured to provide gas to the first portion of the interior volume; and a recirculation passageway having a first port connected to the first portion of the interior volume and a second port connected to the second portion of the interior volume.

In another embodiment, a processing system is provided including: a process chamber comprising: a chamber body enclosing an interior volume; a first substrate support and a second substrate support each positioned in the interior volume, the first substrate support spaced from the second substrate support in a horizontal direction; a first gas inlet and a second gas inlet each configured to provide gas to the interior volume, wherein: the first gas inlet is located on a first side of the interior volume, and the second gas inlet is located on a second side of the interior volume; a first supply line connected to the first gas inlet, the first supply line including a first supply line valve; and a second supply line connected to the second gas inlet, the second supply line including a second supply line valve.

In another embodiment, a process chamber is provided including: a chamber body enclosing an interior volume; a substrate support assembly in the interior volume, the substrate support assembly including a first substrate support, a second substrate support, and a barrier, wherein: the first substrate support is positioned over the second substrate support, the barrier is positioned between the first substrate support and the second substrate support; and the interior volume includes a first portion above the barrier and a second portion below the barrier, a first gas inlet configured to provide gas to the first portion of the interior volume; a recirculation passageway having a first port connected to the first portion of the interior volume and a second port connected to the second portion of the interior volume when the substrate support assembly is in a first position, wherein the first port of the recirculation passageway is located on an opposing side of the interior volume relative to a location of the first gas inlet; and actuator configured to move the substrate support assembly from the first position to a second position.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 shows a side cross-sectional view of a processing system, according to one embodiment.

FIG. 2 is a process flow diagram of a method for performing a process on a plurality of substrates using the processing system of FIG. 1, according to one embodiment.

FIG. 3A shows a side cross-sectional view of a processing system 300, according to one embodiment.

FIG. 3B shows the position of the valves in the processing system of FIG. 3A and the direction of the gas flows during a portion of the process, according to one embodiment.

FIG. 3C shows the position of the valves in the processing system of FIG. 3A and the direction of the gas flows during another portion of the process, according to one embodiment.

FIG. 3D shows the position of the valves in the processing system of FIG. 3A and the direction of the gas flows during another portion of the process, according to one embodiment.

FIG. 3E shows the position of the valves in the processing system of FIG. 3A and the direction of the gas flows during another portion of the process, according to one embodiment.

FIG. 4 is a process flow diagram of a method for performing a process on a plurality of substrates using the processing system of FIG. 3A, according to one embodiment.

FIG. 5A shows a top schematic view of a processing system with valves in a first configuration to direct gas along a first path through the processing system, according to one embodiment.

FIG. 5B shows a top schematic view of the processing system with the valves in a second configuration to direct gas along a second path through the processing system, according to one embodiment.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to improvements in the utilization rates for gases provided to process chambers, such as semiconductor process chambers, when performing processes, such as deposition, etching, or other processes on substrates, such as semiconductor substrates. The utilization rates for the gases provided to the process chambers can be improved by directing the gases along gas flow paths that extend over two or more substrates. Thus, the portion of the gas that does not perform the intended process (e.g., deposition) on the first substrate along the gas flow path has another opportunity to perform the intended process on another substrate along the gas flow path when that portion of the gas flows over the additional one or more substrates. When this gas performs the intended process on one of the one or more additional substrates along the flow path, the gas utilization rate is improved relative to conventional processes that direct gases over a single substrate. Improving this gas utilization rate can reduce operating costs and is also more environmentally friendly as there is less waste. Process uniformity can be maintained for the different substrates being processed by changing the direction of the gas flow as described in fuller detail below.

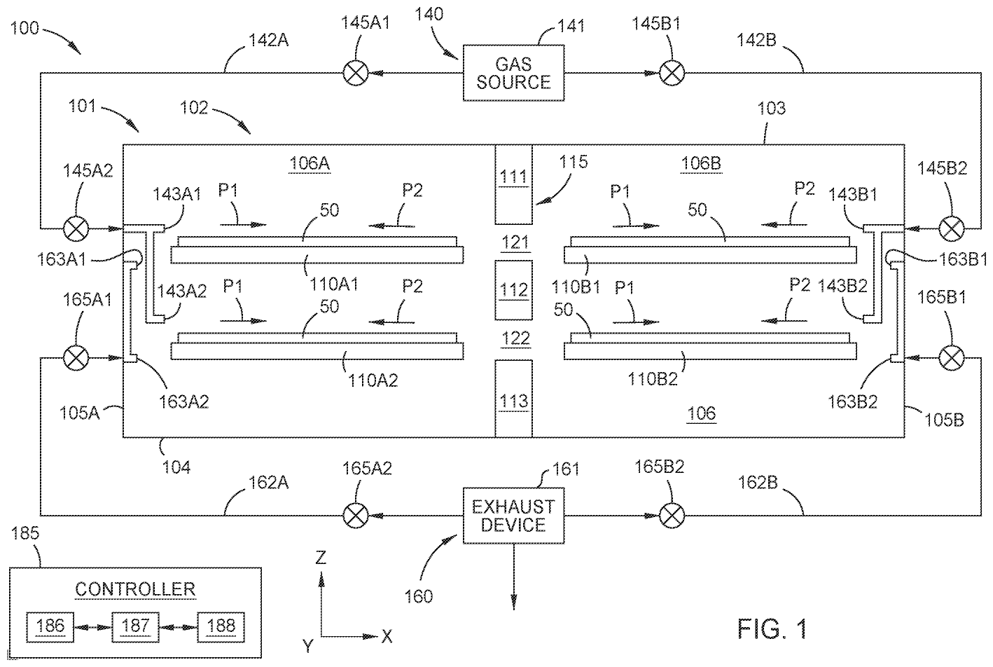

FIG. 1 shows a side cross-sectional view of a processing system 100, according to one embodiment. The processing system 100 includes a process chamber 101, a gas supply system 140, an exhaust system 160, and a controller 185. The process chamber 101 includes a chamber body 102 that encloses an interior volume 106. The chamber body 102 includes a top 103, a bottom 104, a first side 105A, and an opposing second side 105B. Although the chamber body 102 is described as having two opposing sides 105A, 105B, the chamber body 102 can have a circular profile when viewed from above.

The process chamber 101 further includes a barrier 115 that separates the interior volume 106 into a first portion 106A and a second portion 106B. The process chamber 101 includes a first substrate support 110A1 and a second substrate support 110A2 in the first portion 106A of the interior volume 106. The first substrate support 110A1 can be positioned over the second substrate support 110A2. The process chamber 101 also includes a first substrate support 110B1 and a second substrate support 110B2 in the second portion 106B of the interior volume 106. The first substrate support 110B1 can be positioned over the second substrate support 110B2. The first substrate support 110A1 is spaced apart from the first substrate support 110B1 in a horizontal direction at a same vertical position. Similarly, the second substrate support 110A2 is spaced apart from the second substrate support 110B2 in a horizontal direction at a same vertical position. The substrate supports 110A1, 110A2, 110B1, 110B2 can be referred to collectively as the substrate supports 110. A substrate 50 can be positioned on each of the substrate supports 110 for performing processes, such as depositions, in the interior volume 106.

The barrier 115 includes a first portion 111, a second portion 112, and third portion 113. The second portion 112 is located at a vertical location between the first portion 111 and the third portion 113. The first portion 111 can extend downwardly from the top 103 of the chamber body 102. The second portion 112 can extend upwardly from the bottom 104 of the chamber body 102. A first opening 121 is located between the first portion 111 and the second portion 112 of the barrier 115. A second opening 122 is located between the second portion 112 and the third portion 113 of the barrier 115. Gas can flow through the openings 121, 122 during processing as described in further detail below. In some embodiments, the barrier 115 can be omitted.

The gas supply system 140 includes a gas source 141, a first gas supply line 142A, and a second gas supply line 142B. The first gas supply line 142A includes a source valve 145A1 and an inlet valve 145A2. The source valve 145A1 is located close to the gas source 141. The inlet valve 145A2 is located close to the chamber body 102. Similarly, the second gas supply line 142B includes a source valve 145B1 and an inlet valve 145B2. The source valve 145B1 is located close to the gas source 141. The inlet valve 145B2 is located close to the chamber body 102. Locating the inlet valves 145A2, 145B2 close to the chamber body 102 or within the chamber body 102 can help prevent any back flow of gases in the interior volume 106 to the respective gas supply lines 142A, 142B. Each of the valves 145A1, 145A2, 145B1, 145B2 can also be referred to as a supply line valve.

The first gas supply line 142A extends into the first portion 106A of the interior volume 106. The first gas supply line 142A includes a first inlet 143A1 positioned to direct gas from the first gas supply line 142A over the first substrate support 110A1 in the first portion 106A of the interior volume 106. Similarly, the first gas supply line 142A includes a second inlet 143A2 positioned to direct gas from the first gas supply line 142A over the second substrate support 110A2 in the first portion 106A of the interior volume 106.

The second gas supply line 142B extends into the second portion 106B of the interior volume 106. The second gas supply line 142B includes a first inlet 143B1 positioned to direct gas from the second gas supply line 142B over the first substrate support 110B1 in the second portion 106B of the interior volume 106. Similarly, the second gas supply line 142B includes a second inlet 143B2 positioned to direct gas from the second gas supply line 142B over the second substrate support 110B2 in the second portion 106B of the interior volume 106.

The exhaust system 160 includes an exhaust device 161, a first exhaust line 162A, and a second exhaust line 162B. The first exhaust line 162A includes an inlet valve 165A1 and an exhaust valve 165A2. The inlet valve 165A1 is located close to the chamber body 102. The exhaust valve 165A2 is located close to the exhaust device 161. Similarly, the second exhaust line 162B includes an inlet valve 165B1 and an exhaust valve 165B2. The inlet valve 165B1 is located close to the chamber body 102. The exhaust valve 165B2 is located close to the exhaust device 161. Each of the valves 165A1, 165A2, 165B1, 165B2 can also be referred to as an exhaust line valve.

The first exhaust line 162A extends into the first portion 106A of the interior volume 106. The first exhaust line 162A includes a first inlet 163A1 positioned to exhaust gas from around the first substrate support 110A1 to the first exhaust line 162A1. Similarly, the first exhaust line 162A includes a second inlet 163A2 positioned to exhaust gas from around the second substrate support 110A2 to the first exhaust line 162A.

The second exhaust line 162B extends into the second portion 106B of the interior volume 106. The second exhaust line 162B includes a first inlet 163B1 positioned to exhaust gas from around the first substrate support 110B1 to the second exhaust line 162B1. Similarly, the second exhaust line 162B includes a second inlet 163B2 positioned to exhaust gas from around the second substrate support 110B2 to the second exhaust line 162B.

The processing system 100 can also include the controller 185 for controlling processes performed by the processing system 100. The controller 185 can be any type of controller used in an industrial setting, such as a programmable logic controller (PLC). The controller 185 includes a processor 187, a memory 186, and input/output (I/O) circuits 188. The controller 185 can further include one or more of the following components (not shown), such as one or more power supplies, clocks, communication components (e.g., network interface card), and user interfaces typically found in controllers for semiconductor equipment.

The memory 186 can include non-transitory memory. The non-transitory memory can be used to store the programs and settings described below. The memory 186 can include one or more readily available types of memory, such as read only memory (ROM) (e.g., electrically erasable programmable read-only memory (EEPROM), flash memory, floppy disk, hard disk, or random access memory (RAM) (e.g., non-volatile random access memory (NVRAM).

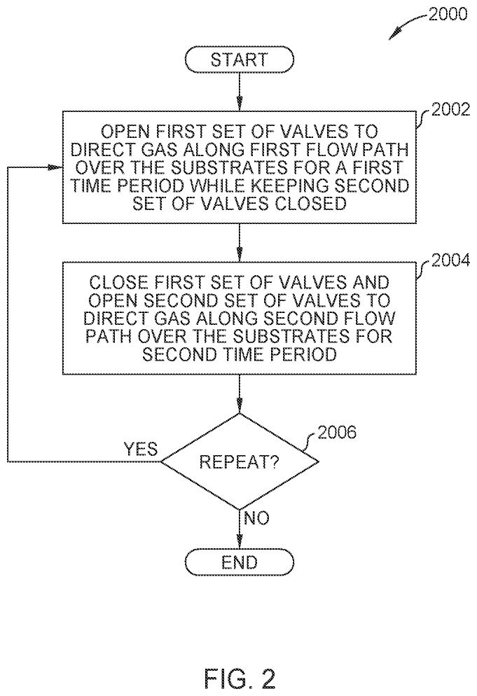

The processor 187 is configured to execute various programs stored in the memory 186, such as a program configured to execute the method 2000 described below in reference to FIG. 2. During execution of these programs, the controller 185 can communicate to I/O devices through the I/O circuits 188. For example, during execution of these programs and communication through the I/O circuits 188, the controller 185 can monitor inputs (e.g., sensors for monitoring pressures and flowrates) and control outputs (e.g., valves) to control the flow of gases through the process chamber 101. The memory 186 can further include various operational settings used to control the processing system 100. For example, the settings can include time settings for how long gas is provided from the gas source 141 during different portions of the method 2000 described below.

FIG. 2 is a process flow diagram of a method 2000 for performing a process on a plurality of substrates using the processing system 100 of FIG. 1, according to one embodiment.

The method begins at block 2002. At block 2002, a first set of valves are opened for a first time period (e.g., 30 seconds) to direct gas from the gas source 141 through the first gas supply line 142A and along a first path P1 in a first direction (the positive X-direction in FIG. 1) over the substrate supports 110 in the interior volume 106 and to second the exhaust line 162B. Opening the first set of valves to direct the gas along the first path P1 includes (1) opening the source valve 145A1 and the inlet valve 145A2 on the first gas supply line 142A, and (2) opening the inlet valve 165B1 and the exhaust valve 165B2 on the second exhaust line 162B. With this first set of valves open, the gas can flow (1) into the first portion 106A of the interior volume 106 through the inlets 143A1, 143A2, then (2) over the substrate supports 110A1, 110A2 in the first portion 106A of the interior volume 106, then (3) over the substrate supports 110B1, 110B2 in the second portion 106B of the interior volume 106, and (4) out of the interior volume 106 through the exhaust inlets 163B1, 163B2. After the first time period expires, the method 2000 proceeds to block 2004.

At block 2004, the first set of valves are closed, and a second set of valves are opened for a second time period (e.g., 30 seconds) to direct gas from the gas source 141 along a second path P2 in a second direction (the negative X-direction in FIG. 1) over the substrate supports 110 in the interior volume 106 and to the first exhaust line 162A. Opening the second set of valves to direct the gas along the second path P2 includes (1) opening the source valve 145B1 and the inlet valve 145B2 on the second gas supply line 142B, and (2) opening the inlet valve 165A1 and the exhaust valve 165A2 on the first exhaust line 162A. With this second set of valves open, the gas can flow (1) into the second portion 106B of the interior volume 106 through the inlets 143B1, 143B2, then (2) over the substrate supports 110B1, 110B2 in the second portion 106B of the interior volume 106, then (3) over the substrate supports 110A1, 110A2 in the first portion 106A of the interior volume 106, and (4) out of the interior volume 106 through the exhaust inlets 163A1, 163A2. After the second time period expires, the method 2000 proceeds to block 2006.

At block 2006, a determination can be made by the controller 185 to repeat blocks 2002 and 2004.

During the first time period at block 2002, the gas flows first over the substrates 50 on the substrate supports 110A1, 110A2, and then over the substrates 50 on the substrate supports 110B1, 110B2. Some of the gas flowing over the substrates 50 on the substrate supports 110A1, 110A2 is essentially unused and does not perform the intended process (e.g., deposition) on those substrates 50. This unused process gas then flows over the substrates 50 positioned on the substrate supports 110B1, 110B2, so that this gas has another opportunity to perform the intended process (e.g., deposition) on a substrate 50. By allowing some of the process gas to flow over one or more additional substrates after flowing over an initial substrate, a higher portion of the gas can be used to perform the intended process (e.g., deposition) and less process gas is wasted, which can reduce cost of production.

During the second time period at block 2004, the flow of gas is reversed, so that during the second time period the gas flows first over the substrates 50 positioned on the substrate supports 110B1, 110B2, and then over the substrates 50 positioned on the substrate supports 110A1, 110A2. Reversing the direction of the gas flow in this way enables each of the substrates 50 to be exposed to the same or substantially the same concentrations of gases over the total time period that includes the first time period of block 2002 and the second time period of block 2004, which enables process uniformity to be maintained across the different substrates 50. For example, the substrates 50 positioned on the substrate supports 110A1, 110A2 are exposed to higher concentration gases during the first time period and lower concentration gases during the second time period. Conversely, the substrates 50 positioned on the substrate supports 110B1, 110B2 are exposed to lower concentration gases during the first time period and higher concentration gases during the second time period.

In some embodiments, the processing system 100 can be modified to include additional substrate supports. For example, the processing system 100 can be modified to include additional substrate supports spaced apart from the substrate supports shown in FIG. 1 in Y-direction with corresponding gas inlets and exhaust inlets added for the additional substrate supports.

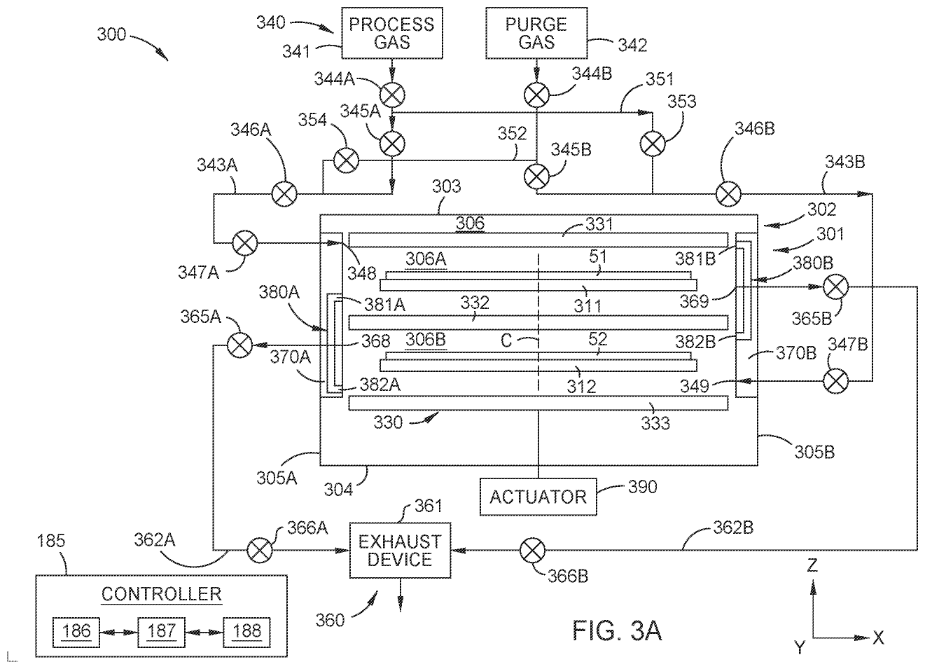

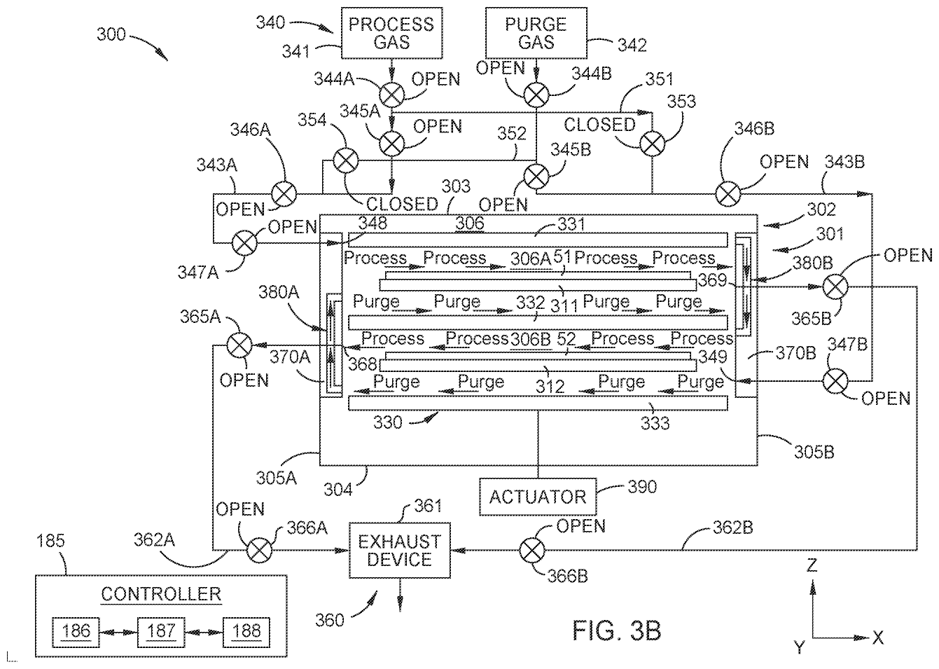

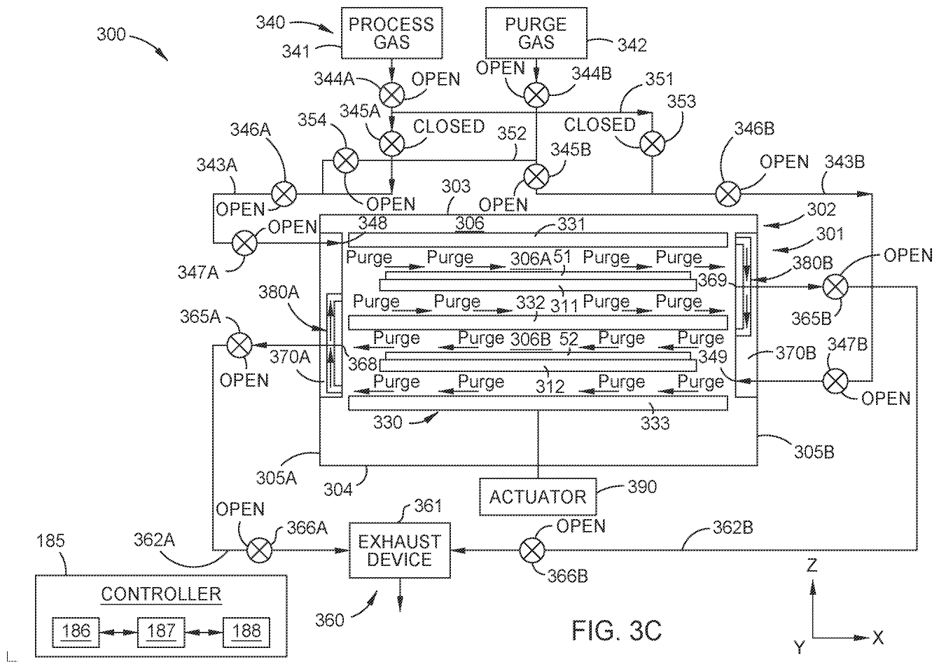

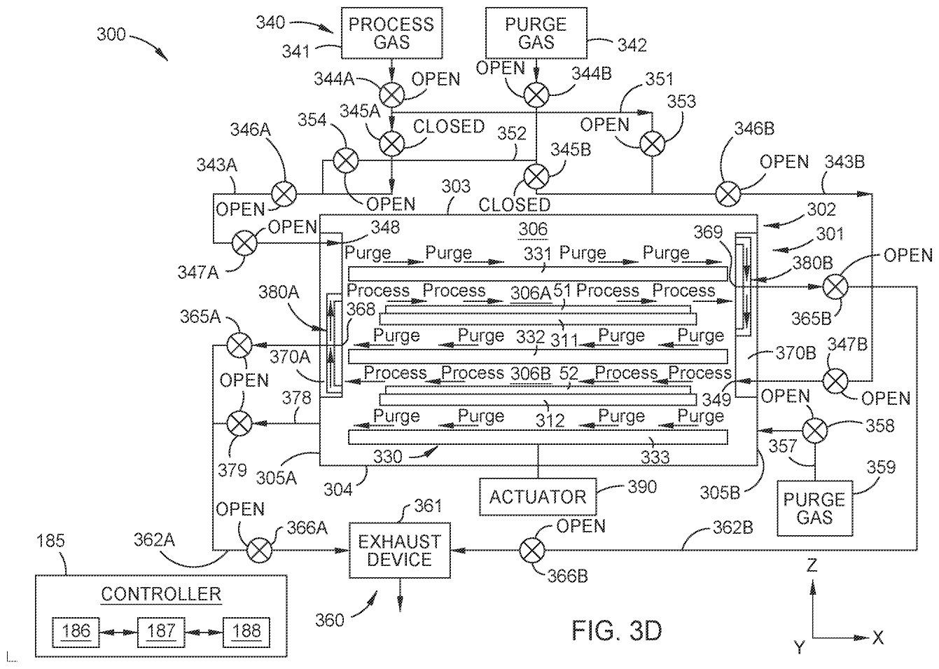

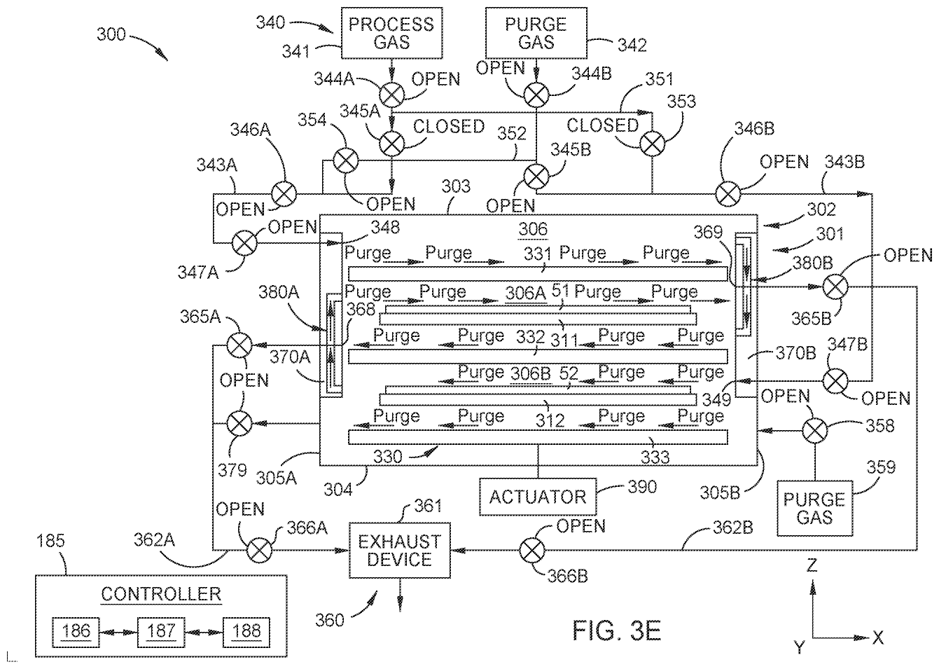

FIG. 3A shows a side cross-sectional view of a processing system 300, according to one embodiment. The processing system 300 includes a process chamber 301, a gas supply system 340, an exhaust system 360, and a controller 185. The controller 185 can be substantially the same controller as the controller 185 described above in reference to FIG. 1 with programs stored in memory that are configured to control processes using the inputs (e.g., sensors) and outputs (e.g., valves) of the processing system 300. The process chamber 301 includes a chamber body 302 that encloses an interior volume 306. The chamber body 302 includes a top 303, a bottom 304, a first side 305A, and an opposing second side 305B. Although the chamber body 302 is described as having two opposing sides 305A, 305B, the chamber body 302 can have a circular profile when viewed from above.

The process chamber 301 further includes a first barrier 331, a second barrier 332, and a third barrier 333. The second barrier 332 is located at a vertical position between the first barrier 331 and the third barrier 333. A first portion 306A of the interior volume 306 is located over the second barrier 332. A second portion 306B of the interior volume 306 is located below the second barrier 332. The second barrier 332 is configured to move vertically as part of the substrate assembly as described below, so the size of the first portion 306A and the second portion 306B can change as the second barrier 332 moves up or down.

The barriers 331-333 can be located close the interior sidewalls or other components (e.g., liners) of the process chamber 301, so that the first portion 306A of the interior volume 306 is substantially isolated from the second portion 306B of the interior volume 306. The barriers 331-333 can be configured so that substantially all (e.g., greater than 95% or greater than 99%) of the gas that flows between the two portions 306A, 306B is through the recirculation passageways described below.

The process chamber 301 includes a first substrate support 311 and a second substrate support 312. The first substrate support 311 is located in the first portion 306A of the interior volume 306. The second substrate support 312 is located in the second portion 306B of the interior volume 306. A first substrate 51 can be positioned on the first substrate support 311. A second substrate 52 can be positioned on the second substrate support 312.

The barriers 331-333 and the substrate supports 311, 312 can be part of a substrate support assembly 330. The processing chamber 301 further includes an actuator 390 that is configured to vertically move the substrate support assembly 330 in the interior volume 306. Vertically moving the substrate support assembly 330 moves the barriers 331-333 and the substrate supports 311, 312 of the substrate support assembly 330 to change the gas flow paths of the process gas and purge gas as described in fuller detail below. In one embodiment, the barriers 331-333 can be connected to each other with vertical supports (not shown), and each of the substrate supports 311, 312 can be connected to at least one of the barriers 331-333, for example using vertical supports (not shown) extending from the corresponding barrier 331-333 to the corresponding substrate support 311, 312 to enable the actuator 390 to move the barriers 331-333 and the substrate supports 311, 312 together as a unit.

The gas supply system 340 includes a process gas source 341, a purge gas source 342, a first supply line 343A, and a second supply line 343B. The first supply line 343A extends from the process gas source 341 to a first gas inlet 348 that is configured to supply gas to the interior volume 306 of the process chamber 301. The first inlet 348 can be located in the interior volume 306 with a horizontal position between the outer edge of the first substrate support 311 and the first side 305A of the chamber body 302. The second supply line 343B extends from the purge gas source 342 to a second gas inlet 349 that is configured to supply gas to the interior volume 306 of the process chamber 301. The second inlet 349 can be located in the interior volume 306 with a horizontal position between the outer edge of the first substrate support 311 and the second side 305B of the chamber body 302.

The vertical position and the horizontal position of the first gas inlet 348 can be different than the vertical position and the horizontal position of the second gas inlet 349 to allow the process gas and the purge gas to flow in opposite directions as described in further detail below. The first gas inlet 348 is located above the second gas inlet 349 in the Z-direction. The second gas inlet 349 is located at an opposing position in the X-direction relative to the first gas inlet 348. For example, in some embodiments, the second gas inlet 349 has an angular location that is positioned 180 degrees from the first gas inlet 348 when using a vertical axis C extending through the centers of the substrate supports 311, 312 as a reference for the angular locations.

The first supply line 343A includes a source valve 344A, a first control valve 345A, a second control valve 346A, and an inlet valve 347A. The source valve 344A is located between the process gas source 341 and the first control valve 345A. The first control valve 345A is located between the source valve 344A and the second control valve 346A. The second control valve 346A is located between the first control valve 345A and the inlet valve 347A. The inlet valve 347A is located between the second control valve 346A and the first gas inlet 348.

The second supply line 343B includes a source valve 344B, a first control valve 345B, a second control valve 346B, and an inlet valve 347B. The source valve 344B is located between the purge gas source 342 and the first control valve 345B. The first control valve 345B is located between the source valve 344B and the second control valve 346B. The second control valve 346B is located between the first control valve 345B and the inlet valve 347B. The inlet valve 347B is located between the second control valve 346B and the second gas inlet 349.

The gas supply system 340 further includes a first crossover line 351 and a second crossover line 352. The first crossover line 351 is configured to supply process gas from the first supply line 343A to the second supply line 343B. The first crossover line 351 includes a crossover valve 353 that is configured to open to supply process gas from the first supply line 343A to the second supply line 343B. The second crossover line 352 is configured to supply purge gas from the second supply line 343B to the first supply line 343A. The second crossover line 352 includes a crossover valve 354 that is configured to open to supply purge gas from the second supply line 343B to the first supply line 343A.

The exhaust system 360 includes an exhaust device 361, a first exhaust line 362A, and a second exhaust line 362B. The first exhaust line 362A extends from the exhaust device 361 to a first exhaust inlet 368 that is configured to exhaust gas from the interior volume 306 of the process chamber 301. The second exhaust line 362B extends from the exhaust device 361 to a second exhaust inlet 369 that is configured to exhaust gas from the interior volume 306 of the process chamber 301.

The vertical position and the horizontal position of the first exhaust inlet 368 can be different than the vertical position and the horizontal position of the second exhaust inlet 369 to assist in changing the flow path of the process gas and the purge gas through the interior volume 306 as described in further detail below. The first exhaust inlet 368 is located below the second exhaust inlet 369 in the Z-direction. The second exhaust inlet 369 is located at an opposing position in the X-direction relative to the first exhaust inlet 368. For example, in some embodiments, the second exhaust inlet 369 has an angular location that is positioned 180 degrees from the first exhaust inlet 368 when using the vertical axis C extending through the centers of the substrate supports 311, 312 as a reference for the angular locations.

The first exhaust line 362A includes an exhaust inlet valve 365A and an exhaust outlet valve 366A. The exhaust inlet valve 365A is located between the exhaust inlet 368 and the exhaust outlet valve 366A. The exhaust outlet valve 366A is located between the exhaust inlet valve 365A and the exhaust device 361.

The second exhaust line 362B includes an exhaust inlet valve 365B and an exhaust outlet valve 366B. The exhaust inlet valve 365B is located between the exhaust inlet 368 and the exhaust outlet valve 366B. The exhaust outlet valve 366B is located between the exhaust inlet valve 365B and the exhaust device 361.

The process chamber 301 further includes a first liner 370A and a second liner 370B. The first liner 370A includes a first recirculation passageway 380A (also referred to as additional recirculation passageway). The second liner 370B includes a second recirculation passageway 380B. The first recirculation passageway 380A can include a first port 381A and a second port 382A. The first port 381A is located over the second port 382A. The different vertical locations of the ports 381A, 382A enable the first passageway 380A to provide a flow path to move gases to different portions of the interior volume 306. For example, the first passageway 380A can be used to provide a flow path from the first portion 306A of the interior volume 306 to the second portion 306B of the interior volume 306 or from the second portion 306B of the interior volume 306 to the first portion 306A of the interior volume 306.

Similarly, the second recirculation passageway 380B can include a first port 381B and a second port 382B. The first port 381B is located over the second port 382B. The different vertical locations of the ports 381B, 382B enable the second passageway 380B to provide a flow path to move gases to different portions of the interior volume 306. For example, the second passageway 380B can be used to provide a flow path from the first portion 306A of the interior volume 306 to the second portion 306B of the interior volume 306 or from the second portion 306B of the interior volume 306 to the first portion 306A of the interior volume 306. Although the recirculation passageways 380A, 380B are shown inside the process chamber 301, in some embodiments, the recirculation passageways can be located outside of the process chamber 301.

The ports 381A, 382A of the first recirculation passageway 380A can be a different vertical locations than the corresponding ports 381B, 382B of the second recirculation passageway 380B to enable the corresponding ports to be in positions that are better suited for recirculating different gases (e.g., process gas or purge gas) or gases in different directions (e.g., up or down) depending on the position of the substrate support assembly 330. Furthermore, the passageways 380A, 380B can be located at opposing locations in the process chamber 301, for example 180 degrees apart from each other relative to a central vertical axis C extending through the centers of the substrate supports 311, 312. Furthermore, the second recirculation passageway 380B can be positioned at an opposing location relative to the first gas inlet 348, for example 180 degrees apart from each other relative to a central vertical axis C extending through the centers of the substrate supports 311, 312. Similarly, the first recirculation passageway 380A can be positioned at an opposing location relative to the second gas inlet 349, for example 180 degrees apart from each other relative to a central vertical axis C extending through the centers of the substrate supports 311, 312. The opposing locations of the recirculation passageways 380A, 380B relative to the gas inlets 348, 349 allows the gases to flow from the gas inlets 348, 349 over the substrates 51, 52 on the substrate supports 311, 312 and across the entire corresponding portions 306A, 306B of the interior volume 306 in the horizontal direction before the gases reach the corresponding recirculation passageway 380A, 380B.

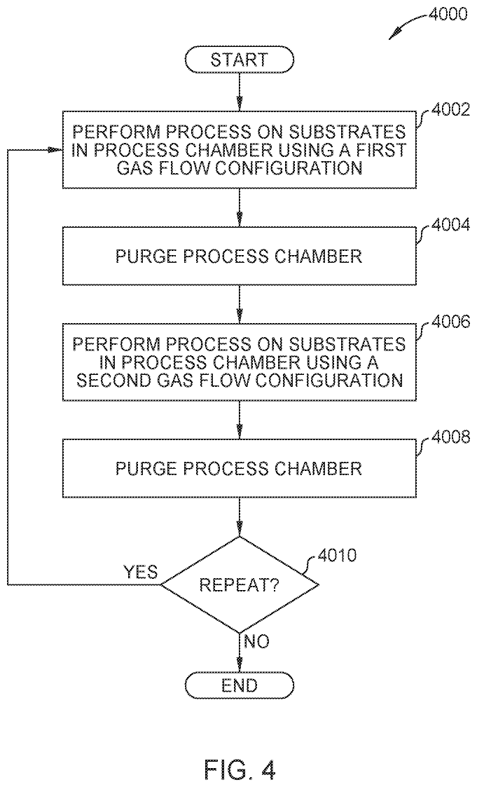

FIG. 4 is a process flow diagram of a method 4000 for performing a process on a plurality of substrates 51, 52 using the processing system 300 of FIG. 3A, according to one embodiment. FIGS. 3B-3E show the processing system 300 during different operations performed in the method 4000. The method 4000 is described as a deposition, but the processing system 300 and the method 4000 can be used to perform other processes on substrates, such as etching, cleaning, or other processes commonly performed on substrates, such as semiconductor substrates.

The method begins at block 4002. At block 4002, a process (e.g., deposition) is performed on the substrates 51, 52 using a first gas flow configuration. FIG. 3B shows the position of the valves in the processing system 300 and the direction of the gas flows during block 4002, according to one embodiment. At block 4002, process gas is provided from the process gas source 341 to the interior volume 306 of the process chamber 301. The process gas flows over the substrates 51, 52, so that a deposition can be performed on the substrates 51, 52. Valves 344A, 345A, 346A, and 347A are opened to allow the process gas to flow through the first supply line 343A and to the first gas inlet 348. Crossover valves 353, 354 remain closed, so that process gas does not flow from the first supply line 343A to the second supply line 343B. Block 4002 can be performed for a first period of time that can be any length of time (e.g., 20 seconds).

During block 4002, the process gas flows through the first supply line 343A and into the first portion 306A of the interior volume 306 through the first gas inlet 348. The process gas then flows over the first substrate 51 on the first substrate support 311. After flowing over the substrate 51 on the first substrate support 311, the process gas flows through the second passageway 380B by entering the first port 381B and exiting the second port 382B (see also FIG. 3A). After exiting the second passageway 380B, the process gas flows into the second portion 306B of the interior volume 306 and over the second substrate 52 on the second substrate support 312. Some of the process gas that did not perform the intended process (e.g., deposition) on the first substrate 51 then flows over the second substrate 52 and does perform the intended process on the second substrate 52. This allows for a higher utilization rate for the process gas as less process gas is wasted, which can reduce costs while also being more environmentally friendly.

Also, during block 4002, purge gas is provided from the purge gas source 342 to the interior volume 306 of the process chamber 301. The purge gas is provided to portions of the interior volume 306 below the substrate supports 311, 312 to assist in preventing process gas from reaching areas of the process chamber 301 that are below the corresponding substrate support 311, 312 and above a next lowest barrier 332, 333. Valves 344B, 345B, 346B, and 347B are opened to allow the purge gas to flow through the second supply line 343B to the second gas inlet 349. Crossover valves 353, 354 remain closed, so that purge gas does not flow from the second supply line 343B to the first supply line 343A.

During block 4002, the purge gas flows through the second supply line 343B and into the second portion 306B of the interior volume 306 through the second gas inlet 349. The purge gas then flows under the second substrate support 312 and into the first passageway 380A by entering the second port 382A and exiting the first port 381A (see also FIG. 3A). After exiting the second passageway 380B, the purge gas flows into the first portion 306A of the interior volume 306 and under the first substrate support 311. In some embodiments, all or substantially all (e.g., >95% or >99%) of the purge gas that is used in the second portion 306B of the interior volume 306 is also used in the first portion 306A of the interior volume 306. Thus, the same purge can be used to prevent process gases from going below two substrate supports 311, 312, which is less costly and more environmentally friendly than conventional processes that provide separate purge gas flows for each substrate support. In some embodiments, the purge gas is provided to the interior volume 306 before the process gas is provided to the interior volume 306 to ensure that adequate pressure of purge gas is provided below each of the substrate supports 311, 312 before the process gas is provided to the portions 306A, 306B of the interior volume 306. This delay (e.g., 5 seconds) can allow the purge gas time to flow through the first passageway 380A and into the first portion 306A of the interior volume 306 before the process gas is provided to the interior volume 306.

At block 4002, valves 365A, 366A on the first exhaust line 362A are opened to allow the process gas to be exhausted by the exhaust device 361 from second portion 306B of the interior volume 306 after the process gas flows over the second substrate 52. At block 4002, valves 365B, 366B are opened on the second exhaust line 362B to allow the purge gas to be exhausted by the exhaust device 361 from the first portion 306A of the interior volume 306 after the purge gas flows under the first substrate support 311.

At block 4004, the interior volume 306 of the process chamber 301 is purged. FIG. 3C shows the position of the valves and the directions of the gas flows during block 4004, according to one embodiment. Most of the valves remain in the same position as during block 4002. Valve 345A is closed during block 4004 to stop the flow of process gas from the process gas source 341 through the first supply line 343A. Crossover valve 354 is opened to allow purge gas to flow from the purge gas source 342 and into the first portion 306A of the interior volume 306 through the first supply line 343A. The purge gas flowing through the first supply line 343A flows through the interior volume 306 of the process chamber 301 along the same path as described above for the process gas during block 4002. Block 4004 can be performed for a period of time that can be any length of time (e.g., 15 seconds). Purge gas also continues to flow through the second supply line 343B and through the interior volume 306 using the same path as described above for the flow of the purge gas during block 4002.

At block 4006, the process (e.g., deposition) is performed on the substrates 51, 52 using a second gas flow configuration. FIG. 3D shows the position of the valves and the directions of the gas flows during block 4006, according to one embodiment. At the beginning of block 4006, the actuator 390 moves the substrate support assembly 330 downward from the first position shown in FIGS. 3A-3C to a second position shown in FIGS. 3D and 3E. In the second position, the first gas inlet 348 and the first port 381B of the second recirculation passageway 380B are each above the first barrier 331. Also, in the second position, the second port 382A of the first recirculation passageway 380A and the first exhaust inlet 368 are located above the second barrier 332.

At block 4006, the valves 345A, 345B are closed, and the crossover valves 353, 354 are opened, which allows the flows of the process gas and the purge gas to be switched when compared to block 4002. For example, the process gas flows through the second portion 306B of the interior volume 306 first and then through the first portion 306A of the interior volume 306. The purge gas flows through the first portion 306A of the interior volume 306 first and then through the second portion 306B of the interior volume 306. This reversal of flow direction allows the second substrate 52 to be exposed to process gas having a higher concentration than during block 4002 and allows the first substrate 51 to be exposed to process gas having a lower concentration than during block 4002. The time periods for block 4002 and block 4006 can be set to be the same (e.g., each 20 seconds) or adjusted to ensure that process uniformity on the substrates 51, 52 is achieved.

During block 4006, the process gas flows from the process gas source 341 through the first crossover line 351 and into the second supply line 343B. The process gas then flows through the second supply line 343B to the second gas inlet 349 and into a region of the second portion 306B of the interior volume 306 above the substrate 52 on the second substrate support 312. The process gas then flows over the substrate 52 on the second substrate support 312 and into the second port 382A (see FIG. 3A) of the recirculation passageway 380A. The process gas then flows through the first recirculation passageway 380A and enters a region of the first portion 306A of the interior volume 306 above the substrate 51 on the first substrate support 311. The process gas then flows over the first substrate support 311 to the second exhaust inlet 369 after which the process gas is exhausted by the exhaust device 361 through the second exhaust line 362B.

During block 4006, the purge gas flows from the purge gas source 342 through the second crossover line 352 to the first supply line 343A. The purge gas then flows through the first supply line 343A to the first gas inlet 348 and into a region of the first portion 306A of the interior volume 306 above the first barrier 331. The purge gas then flows over the first barrier and into the first port 381B (see FIG. 3A) of the recirculation passageway 380B. The purge gas then flows through the second recirculation passageway 380B and enters the region of the first portion 306A of the interior volume 306 below the first substrate support 311. The purge gas then flows under the first substrate support 311 to the first exhaust inlet 368 after which the purge gas is exhausted by the exhaust device 361 through the first exhaust line 362A.

The processing system 300 can further include an auxiliary purge gas source 359, an auxiliary purge gas line 357, and an auxiliary purge gas valve 358 on the auxiliary purge gas line 357 to provide purge gas below the second substrate support 312 when the substrate support assembly 330 is in the second position as shown in FIG. 3D. The processing system 300 can further include an auxiliary exhaust line 378 that includes an auxiliary exhaust valve 379 to exhaust the purge gas provided below the second substrate support 312 when the substrate support assembly 330 is in the second position shown in FIG. 3D. The auxiliary exhaust line can connect to the first exhaust line 362A, so that the purge gas provided below the second substrate support 312 can be exhausted from the interior volume 306 by the exhaust device 361.

In some embodiments, the process chamber 301 can include a third recirculation passageway (not shown), so that the purge gas flowing below the first substrate support 311 in FIG. 3D can then be recirculated to flow below the second substrate support 312. This third recirculation passageway can reduce the amount of purge gas needed to perform a process, which can reduce operating costs. In some embodiments, the recirculation passageways can include valves to control when gas enters the passageway. Although two substrate supports 311, 312 are shown in the process chamber 301, other embodiments can include three or more substrate supports arranged vertically with additional recirculation passageways added for each additional substrate support.

At block 4008, the interior volume 306 of the process chamber 301 is purged. FIG. 3E shows the position of the valves and the directions of the gas flows during block 4008, according to one embodiment. Most of the valves remain in the same position as during block 4006. The purge gas flows from block 4006 continue along the same flow paths as described above for block 4006. Crossover valve 353 is closed during block 4008 to stop the flow of process gas. Valve 345B is opened to allow purge gas to flow through the second supply line 342B and through the interior volume 306 using the same path as the process gas during block 4006.

At block 4010, a determination can be made by the controller 185 to repeat blocks 4002 through 4008. As shown in FIGS. 3B-3E, the processing system 300 is configured to enable the same process gas to flow over two substrates and for the same purge gas to flow below two substrate supports, which results in a higher utilization rate for the process gas and purge gas compared to conventional processing systems that provide separate process gas and purge gas for each substrate and substrate support. Also, as shown in FIGS. 3B and 3D, the flow of the process gas can be reversed, so that first substrate 51 receives higher concentration process gas during block 4002 (FIG. 3B), and the second substrate 52 receives higher concentration process gas during block 4006 (FIG. 3D). Reversing the flow of the process gas can enable process uniformity to be maintained across the different substrates.

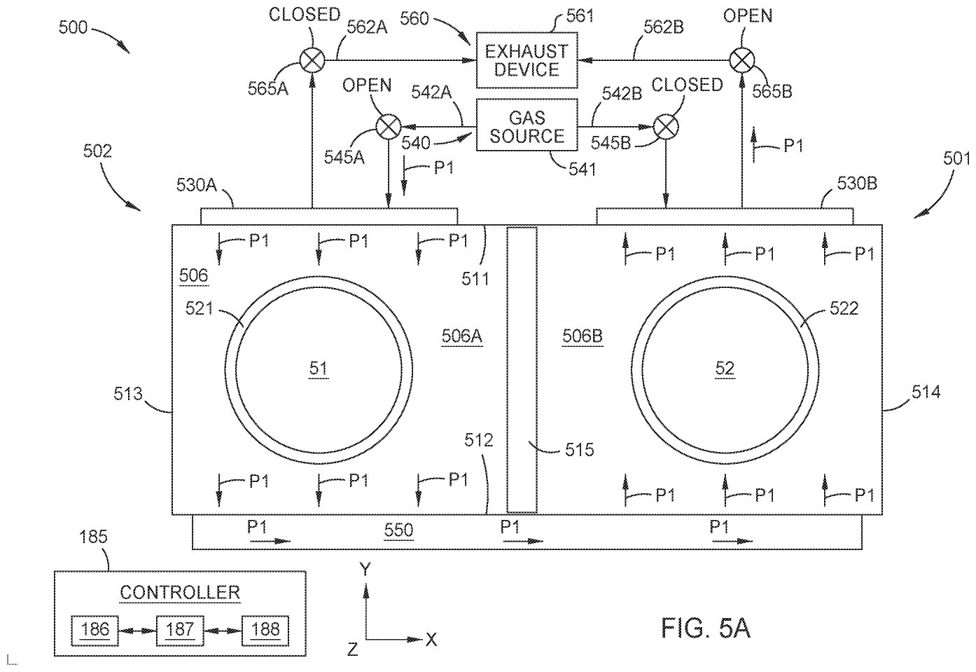

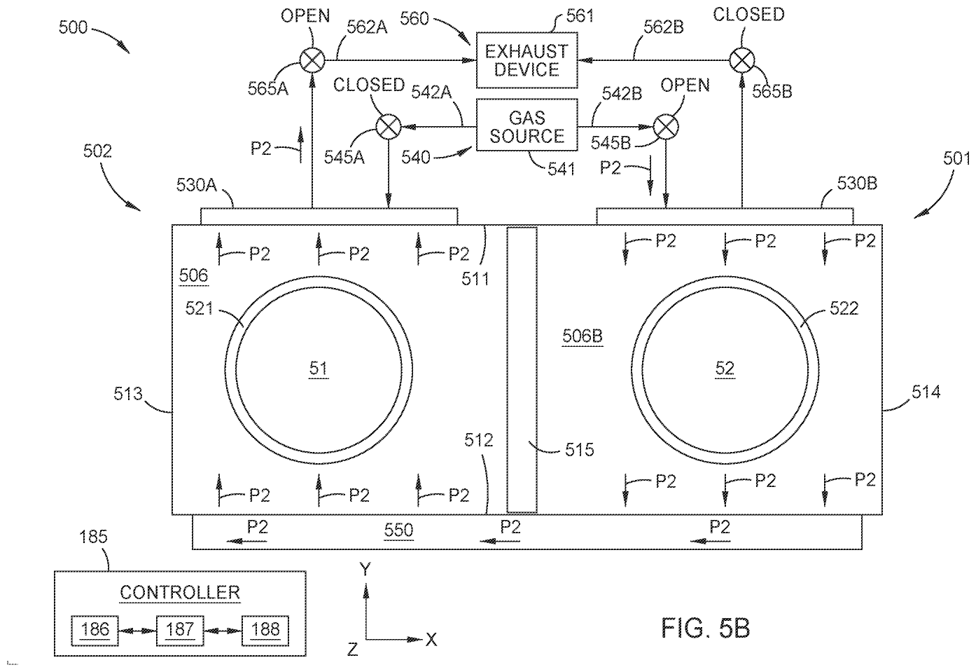

FIG. 5A shows a top schematic view of a processing system 500 with valves in a first configuration to direct gas along a first path P1 through the processing system 500, according to one embodiment. The processing system 500 includes a process chamber 501, a gas supply system 540, an exhaust system 560, and a controller 185. The controller 185 can be substantially the same controller as the controller 185 described above in reference to FIG. 1 with programs stored in memory that are configured to control processes using the inputs (e.g., sensors) and outputs (e.g., valves) of the processing system 500. The process chamber 501 includes a chamber body 502 that encloses an interior volume 506. The chamber body 502 includes a top and a bottom (both not shown) and a plurality of sides 511-514. The plurality of sides 511-514 connect the bottom of the chamber body 502 to the top of the chamber body 502.

The process chamber 501 further includes a barrier 515 that separates the interior volume 506 into a first portion 506A and a second portion 506B. The process chamber 501 includes a first substrate support 521 in the first portion 506A of the interior volume 506 and a second substrate support 522 in the second portion 506B of the interior volume 506. A first substrate 51 is positioned on the first substrate support 521. A second substrate 52 is positioned on the second substrate support 522.

The plurality of sides of the chamber body 502 includes a first side 511, a second side 512, a third side 513, and a fourth side 514. The first side 511 is located on the opposing side of the second side 512. Similarly, the third side 513 is located on the opposing side of the fourth side 514. The process chamber 501 further includes a first gas exchanger 530A located at the first side 511 of the chamber body 502 to provide gas to the first portion 506A of the interior volume 506 or to exhaust gas from the first portion 506A of the interior volume 506. The process chamber 501 further includes a second gas exchanger 530B located at the first side 511 of the chamber body 502 to provide gas to the second portion 506B of the interior volume 506 or to exhaust gas from the second portion 506B of the interior volume 506.

The process chamber 501 further includes a recirculation passageway 550 to allow gas to flow (1) from the first portion 506A to the second portion 506B of the interior volume 506, or (2) from the second portion 506B to the first portion 506A of the interior volume 506. The barrier 515 prevents gas from flowing between the portions 506A, 506B without going through the recirculation passageway 550. In some embodiments, the recirculation passageway 550 as well as the recirculation passageways in the processing system 300 can include one or more particle filters to remove any particles that flow through the passageway, which can improve process results. Furthermore, in some embodiments, some fresh process gas can be added to a recirculation passageway, such as to the recirculation passageways described in the processing systems 300 and 500, so that the gas exiting the recirculation passageway is a mixture of fresh process gas and recirculated process gas. The addition of some fresh process gas can increase the rate of the process (e.g., deposition rate), so that throughput can be increased.

The gas supply system 540 includes a gas source 541 (e.g., process gas source for a deposition), a first gas supply line 542A, and a second gas supply line 542B. The first gas supply line 542A connects the gas source 541 to the first gas exchanger 530A. The second gas supply line 542B connects the gas source 541 to the second gas exchanger 530B. The first gas supply line 542A includes a first gas supply line valve 545A. The second gas supply line 542B includes a second gas supply line valve 545B.

The exhaust system 560 includes an exhaust device 561, a first exhaust line 562A, and a second exhaust line 562B. The first exhaust line 562A connects the exhaust device 561 to the first gas exchanger 530A. The second exhaust line 562B connects the exhaust device 561 to the second gas exchanger 530B. The first exhaust line 562A includes a first exhaust line valve 565A. The second exhaust line 562B includes a second exhaust line valve 565B.

In FIG. 5A, the process gas from the gas source 541 is directed through the processing system 500 along a first path P1. The first path P1 extends (1) from the gas source 541 through the first gas supply line 542A to the first gas exchanger 530A, (2) from the first gas exchanger 530A located at the first side 511 of the chamber body 502 through the first portion 506A of the interior volume 506 over the first substrate support 521 and to the recirculation passageway 550, (3) from the recirculation passageway 550 through the second portion 506B of the interior volume 506 over the second substrate support 522 and to the second gas exchanger 530B, and (4) from the second gas exchanger 530B through the second exhaust line 562B and to the exhaust device 561.

FIG. 5B shows a top schematic view of the processing system 500 with the valves in a second configuration to direct gas along a second path P2 through the processing system 500, according to one embodiment. In FIG. 5B, the process gas from the gas source 541 is directed through the processing system 500 along a second path P2. The second path P2 extends (1) from the gas source 541 through the second gas supply line 542B to the second gas exchanger 530B, (2) from the second gas exchanger 530B located at the first side 511 of the chamber body 502 through the second portion 506B of the interior volume 506 over the second substrate support 522 and to the recirculation passageway 550, (3) from the recirculation passageway 550 through the first portion 506A of the interior volume 506 over the first substrate support 521 and to the first gas exchanger 530A, and (4) from the first gas exchanger 530A through the first exhaust line 562A and to the exhaust device 561. The processing system 500 can be configured to provide the gas over the substrates using the first flow path P1 and the second flow path P2 for similar time periods (e.g., each 20 seconds), so that each substrate 51, 52 is exposed to similar concentrations of gas over the total process (e.g., deposition).

On the first path P1 (FIG. 5A), the process gas first flows over the first substrate 51 in the first portion 506A of the interior volume 506 and then over the second substrate 52 in the second portion 506B of the interior volume 506. On the second path P2 (FIG. 5B), the process gas first flows over the second substrate 52 in the second portion 506B of the interior volume 506 and then over the first substrate 51 in the first portion 506A of the interior volume 506. Thus, on each flow path P1, P2, the process gas that does not perform the intended process (e.g., deposition) on the initial substrate has a second opportunity to perform the intended process on the other substrate. Having some of the same process gas flow over two substrates as opposed to a single substrate in conventional processes can increase the utilization rate of the process gas, which can decrease operating costs and is also more environmentally friendly. Each of the processing systems 100, 300, 500 described above are configured to reverse the direction (e.g., horizontal direction) in which the process gas flows over the substrates, for example by 180 degrees, which can help maintain process uniformity. For example, reversing the direction of the flow path P2 in FIG. 5B relative to the direction of the flow path P1 in FIG. 5A can help maintain process uniformity across the different substrates as the substrates can each be exposed to similar concentrations of gases over the entire process. The operations shown in FIGS. 5A and 5B can be repeated any number of times when processing the substrates.

Although only two substrate supports are shown in the processing system 500, other embodiments can include additional substrate supports. For example, in one embodiment, each portion 506A, 506B of the interior volume 506 can include two or more substrate supports spaced apart in the X-direction allowing for each of the substrates on the two or more substrate supports to receive high concentration process gas during flow path P1 (FIG. 5A) or flow path P2 (FIG. 5B).

While the foregoing is directed to examples of the present disclosure, other and further examples of the disclosure may be devised without departing from the basic scope thereof, and the scope thereof is determined by the claims that follow.

What is claimed is:

1. A process chamber comprising:
a chamber body enclosing an interior volume;
a first substrate support and a second substrate support each positioned in the interior volume, the first substrate support positioned over the second substrate support;
a barrier positioned between the first substrate support and the second substrate support, the interior volume including a first portion above the barrier and a second portion below the barrier;
a first gas inlet configured to provide gas to the first portion of the interior volume; and
a recirculation passageway having a first port connected to the first portion of the interior volume and a second port connected to the second portion of the interior volume.

2. The process chamber of claim 1, wherein the first port of the recirculation passageway is positioned at an angular location that is 180 degrees apart from the first gas inlet relative to a vertical central axis extending through a center of the first substrate support and a center of the second substrate support.

3. The process chamber of claim 1, wherein the first port of the recirculation passageway is located on an opposing side of the interior volume relative to a location of the first gas inlet.

4. The process chamber of claim 3, further comprising a first gas outlet configured to exhaust gas from the second portion of the interior volume, wherein the second port of the recirculation passageway is located on an opposing side of the interior volume relative to a location of the first gas outlet.

5. The process chamber of claim 4, wherein:
the first gas inlet and the first port of the recirculation passageway are each located at a first vertical location, and
the first gas outlet and the second port of the recirculation passageway are each located at a second vertical location.

6. The process chamber of claim 4, further comprising:
a second gas inlet; and
an additional recirculation passageway having a first port above connected to the first portion of the interior volume and a second port connected to the second portion of the interior volume.

7. The process chamber of claim 6, wherein the first port of the additional recirculation passageway is positioned at an angular location that is 180 degrees apart from the second gas inlet relative to a vertical central axis extending through a center of the first substrate support and a center of the second substrate support.

8. The process chamber of claim 6, wherein the first port of the additional recirculation passageway is located on an opposing side of the interior volume relative to a location of the second gas inlet.

9. The process chamber of claim 8, further comprising a second gas outlet configured to exhaust gas from the second portion of the interior volume, wherein the second port of the additional recirculation passageway is located on an opposing side of the interior volume relative to a location of the second gas outlet.

10. The process chamber of claim 9, wherein:
the second gas inlet and the first port of the additional recirculation passageway are each located at a first vertical location, and
the second gas outlet and the second port of the additional recirculation passageway are each located at a second vertical location.

11. A processing system comprising:
a process chamber comprising:
a chamber body enclosing an interior volume;
a first substrate support and a second substrate support each positioned in the interior volume, the first substrate support spaced from the second substrate support in a horizontal direction;
a first gas inlet and a second gas inlet each configured to provide gas to the interior volume, wherein:
the first gas inlet is located on a first side of the interior volume, and
the second gas inlet is located on a second side of the interior volume;
a first supply line connected to the first gas inlet, the first supply line including a first supply line valve; and
a second supply line connected to the second gas inlet, the second supply line including a second supply line valve.

12. The processing system of claim 11, further comprising a controller configured to direct gas along a first path in the interior volume by opening the first supply line valve during a first time period, wherein:
the first path extends from the first gas inlet to a first portion of the interior volume located over the first substrate support,
the first path continues to extend from the first portion of the interior volume to a second portion of the interior volume located over the second substrate support, and
the second supply line valve remains closed during the first time period.

13. The processing system of claim 12, wherein the controller is further configured to direct gas along a second path in the interior volume by opening the second supply line valve during a second time period, wherein:
the second path extends from the second gas inlet to the second portion of the interior volume located over the second substrate support,
the second path continues to extend from the second portion of the interior volume to the first portion of the interior volume located over the first substrate support, and
the first supply line valve remains closed during the second time period.

14. The processing system of claim 11, further comprising:
a first exhaust inlet and a second exhaust inlet each configured to exhaust gas from the interior volume, wherein the first exhaust inlet is located on the first side of the interior volume and the second exhaust inlet is located on the second side of the interior volume;
a first exhaust line connected to the first exhaust inlet, the first exhaust line including a first exhaust line valve; and
a second exhaust line connected to the second exhaust inlet, the second exhaust line including a second exhaust line valve.

15. The processing system of claim 14, further comprising a controller configured to:
open the second exhaust line valve during a first time period to exhaust gas from the interior volume through the second exhaust line during the first time period; and
open the first exhaust line valve during a second time period to exhaust gas from the interior volume through the first exhaust line during the second time period, wherein the first exhaust line valve remains closed during the first time period and the second exhaust line valve remains closed during the second time period.

16. A process chamber comprising:
a chamber body enclosing an interior volume;
a substrate support assembly in the interior volume, the substrate support assembly including a first substrate support, a second substrate support, and a barrier, wherein:
the first substrate support is positioned over the second substrate support,
the barrier is positioned between the first substrate support and the second substrate support; and
the interior volume includes a first portion above the barrier and a second portion below the barrier,
a first gas inlet configured to provide gas to the first portion of the interior volume;
a recirculation passageway having a first port connected to the first portion of the interior volume and a second port connected to the second portion of the interior volume when the substrate support assembly is in a first position, wherein the first port of the recirculation passageway is located on an opposing side of the interior volume relative to a location of the first gas inlet; and
actuator configured to move the substrate support assembly from the first position to a second position.

17. The process chamber of claim 16, wherein the second port is connected to the first portion of the interior volume when the substrate support assembly is in the second position.

18. The process chamber of claim 16, further comprising:
a second gas inlet configured to provide gas to the first portion of the interior volume; and
an additional recirculation passageway having a first port connected to the first portion of the interior volume and a second port connected to the second portion of the interior volume when the substrate support assembly is in the first position, wherein the first port of the additional recirculation passageway is located on an opposing side of the interior volume relative to a location of the second gas inlet.

19. The process chamber of claim 18, wherein:
the first port of the additional recirculation passageway is located above the first substrate support in the first position, and
the first port of the additional recirculation passageway is located below the first substrate support in the second position.

20. The process chamber of claim 18, wherein:
the first port of the additional recirculation passageway is below the first port of the recirculation passageway, and
the second port of the additional recirculation passageway is below the second port of the recirculation passageway.
